(19) United States
(12) Patent Application Publication
(10) Pub. No.: US 2015/0103620 A1
(43) Pub. Date: Apr. 16, 2015

(54) BULK MIXING CONTAINER AND LOCKING BEARING THEREFOR

(71) Applicant: American Machining, Inc., Fenton, MI (US)

(72) Inventor: George P. Stolzenfeld, Holly, MI (US)

(21) Appl. No.: 14/515,174

(22) Filed: Oct. 15, 2014

Related U.S. Application Data
(60) Provisional application No. 61/891,139, filed on Oct. 15, 2013.

(51) Int. Cl. F16C 35/02; F16C 33/20; B01F 15/00

(52) U.S. Cl. CPC F16C 35/02; B01F 15/00668; F16C 33/20; B01F 2215/005; B01F 2015/0011
USPC 366/204; 384/296

(57) ABSTRACT

A bulk mixing container that includes a container housing, an agitator mounting structure, an agitator assembly, and a bearing. The bearing is mounted in an opening in the agitator mounting structure with a shaft of the agitator assembly extending through a central bore in the bearing. The bearing has a cylindrical body that includes a flange at one end which engages an upper surface of the agitator mounting structure, and a locking tab at its other end which engages a lower surface of the agitator mounting structure to thereby hold the bearing in place. An O-ring fitted into a groove on the outer cylindrical surface of the body provides a secondary seal against fluid movement between the bearing and agitator mounting structure.

### CROSS-REFERENCE TO RELATED APPLICATION

This application claims the benefit of U.S. Provisional Ser. No. 61/891,139 filed on Oct. 15, 2013, the entire contents of which are hereby incorporated by reference.

### TECHNICAL FIELD

This invention relates generally to bearings used to accommodate agitator assemblies in bulk mixing containers.

### BACKGROUND

It is a common practice in some industries to ship or transport materials in a bulk mixing container or tank which is also used as a supply tank for the same material at a work station in the user's facility. For example, in the automotive industry, bulk mixing containers may hold two hundred gallons or more of paint. Agitating the paint directly in the transporting container allows for a homogeneous paint mixture while dispensing the paint from the container. For this purpose, the container has an agitator assembly which comprises an impeller mounted on an agitator shaft which extends through a bearing in the top of the container for connection with an externally mounted drive motor. Over time and prolonged mixing, the agitator shaft may develop a slight bend or curvature. Any slight misalignment or deviation of the vertical axis of the agitator shaft with respect to the vertical axis of the bearing may result in axial movement of the bearing, and may eventually cause an undesirable metal-to-metal interface between the agitator shaft and the container. Accordingly, minimizing axial movement of the bearing during operation of the agitator shaft may limit and/or avoid such an undesirable metal-to-metal interface.

### SUMMARY

In accordance with one embodiment of the invention there is provided a locking bearing for use in a bulk mixing container. The locking bearing includes a body extending from a first axial end to a second axial end and having a central cylindrical bore that receives an agitator shaft when in use. The body has an outer surface shaped for receipt within an opening of an agitator mounting structure of a bulk mixing container such that the bearing may be mounted to the bulk mixing container and the agitator shaft may extend into the bulk mixing container through the bore to permit rotation of the agitator shaft relative to the bulk mixing container to thereby stir contents within the bulk mixing container. The body includes a radially-extending flange at the first axial end for engagement with an upper surface of the agitator mounting structure at the opening in the bulk mixing container to thereby prevent the bearing from passing through the opening. The body includes at least one locking tab locating at the second axial end that extends radially from the body. The locking tab provides a lower retention feature that engages a lower surface of the agitator mounting structure at the opening when the bearing is installed through the opening. In this way, the bearing may be positively locked in place within the opening by engagement of the flange with the upper surface of the agitator mounting structure and engagement of the retention feature of the locking tab with the lower surface of the agitator mounting structure.

In accordance with one embodiment of the invention there is provided a bulk mixing container that includes a container housing, an agitator mounting structure, an agitator assembly, and a bearing. The container housing has a bottom, at least one side wall, and a top. The agitator mounting structure is located at the top of the container housing and has an upper surface located outside the container housing and a lower surface located inside the container housing. The agitator assembly includes a shaft extending through an opening in the agitator mounting structure. The bearing comprises a body extending from a first axial end to a second axial end and having a central cylindrical bore. The body is mounted within the opening of the agitator mounting structure with the shaft extending into the container housing through the bore to permit rotation of the shaft relative to the container housing to thereby stir contents within the container housing. The body includes a radially-extending flange at the first axial end for engagement with the upper surface of the agitator mounting structure at the opening to thereby prevent the bearing from passing through the opening. The body includes at least one locking tab locating at the second axial end that extends radially from the body, the locking tab providing a lower retention feature that engages the lower surface of the agitator mounting structure at the opening. In this way, the bearing is positively locked in place within the opening by engagement of the flange with the upper surface of the agitator mounting structure and engagement of the retention feature of the locking tab with the lower surface of the agitator mounting structure.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is a partial cutaway cross-sectional view of a bulk mixing container having an agitator assembly extending through a locking bearing mounted into an agitator mounting structure;

FIG. 2 is an enlarged cross-sectional view of the locking bearing and 0-ring mounted into the agitator mounting structure of FIG. 1;

FIG. 3 is an enlarged cross-sectional view of the locking bearing of FIG. 1 and FIG. 2; and

FIG. 4 is an enlarged cross-sectional view of the locking bearing of FIGS. 1-3.

### DETAILED DESCRIPTION

The locking bearing described herein may be used in bulk mixing containers which allow for both transportation and dispensing of the container contents. The locking bearing is capable of providing a reliable seal to prevent leakage of the container contents between the agitator shaft and the bearing during shipping and operation of the mixing device. During operation, deflection of the agitator shaft may result from shaft bending loads, which may cause axial movement of the bearing. The locking bearing as described herein can help to resist axial movement that may result from a misalignment between the vertical axis of the agitator shaft and the vertical axis of the locking bearing.

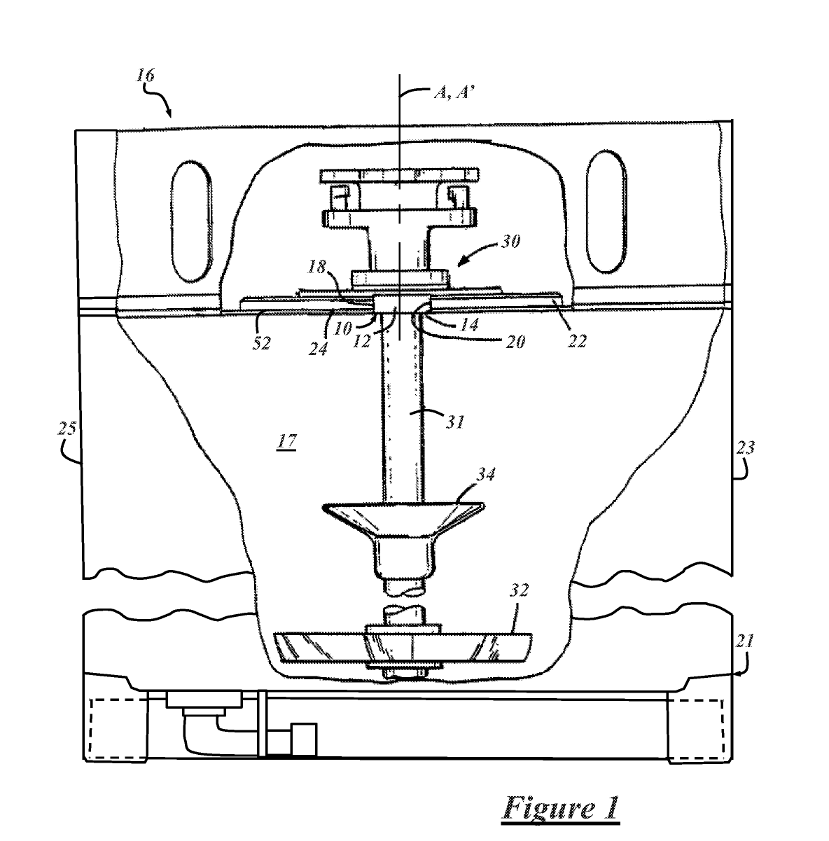

With reference to FIG. 1, a locking bearing 10 generally accommodates an agitator assembly 30 and is mounted, or otherwise fitted, into a tank opening 14 of a bulk mixing container 16. The bulk mixing container 16 comprises a container housing 17 which has a bottom 21, side walls 23, 25, and a top 24. In embodiments where housing 17 is cylindrical, side walls 23, 25 may together comprise a single, cylindrical side wall. The bearing 10 is generally comprised of a body 12 made from a polymeric material, although other materials are certainly possible. An outer surface 18 of bearing 10 is generally aligned with an opening 20 in an agitator mounting structure 22 situated on the top 24 of the container housing 17. As used herein, “agitator mounting structure” refers to the structure at the top 24 of the container housing 17 where the bearing 10 and agitator assembly 30 is mounted. Agitator mounting structure 22 is located at the top 24 of the container housing 17 and has an upper surface 45 located outside of the container housing 17 and a lower surface 52 which is located inside of the container housing 17. In some embodiments, the agitator mounting structure may include a portion of the upper wall of the container generally surrounding an opening for an agitator shaft, or it may be a separate reinforcing element disposed on the upper wall of a bulk mixing container. As shown in more detail in FIG. 2, bearing 10 has a locking tab 28 with a lower retention feature 50 that helps restrain axial movement of the bearing during operation. Locking tab 28 also serves as a primary seal to help prevent leakage of the container contents. The bearing 10 may also include an O-ring 26. O-ring 26 acts a secondary seal to further prevent leakage of the container contents. The bearing 10 provides journaled support for an agitator shaft 31 that rotatably operates to stir the contents of container 16.

When the container 16 is in use, a motor rotatively drives the agitator shaft 31 of and an impeller 32 of the agitator assembly 30, which is immersed in the contents of the container housing 17. In order to further prevent leakage of the contents through the tank opening 14 and the opening 20 of the agitator mounting structure 22, a rotor in the form of a centrifugal slinger 34 is mounted on the agitator shaft 31 for rotation therewith. The rotational motion of the agitator shaft 31 may have a tendency to cause the contents in the container to climb upwards on the shaft below the slinger 34 and onto the lower surface of the slinger. Because of the inverted cone shape of the slinger 32, material on the cone surface may climb toward the upper and may be thrown outwardly by centrifugal force. Thus, the tank opening 14 and the opening 20 of the agitator mounting structure 22 which house the bearing 10 may be further shielded from the contents of container 16 and the potential for leakage may be decreased.

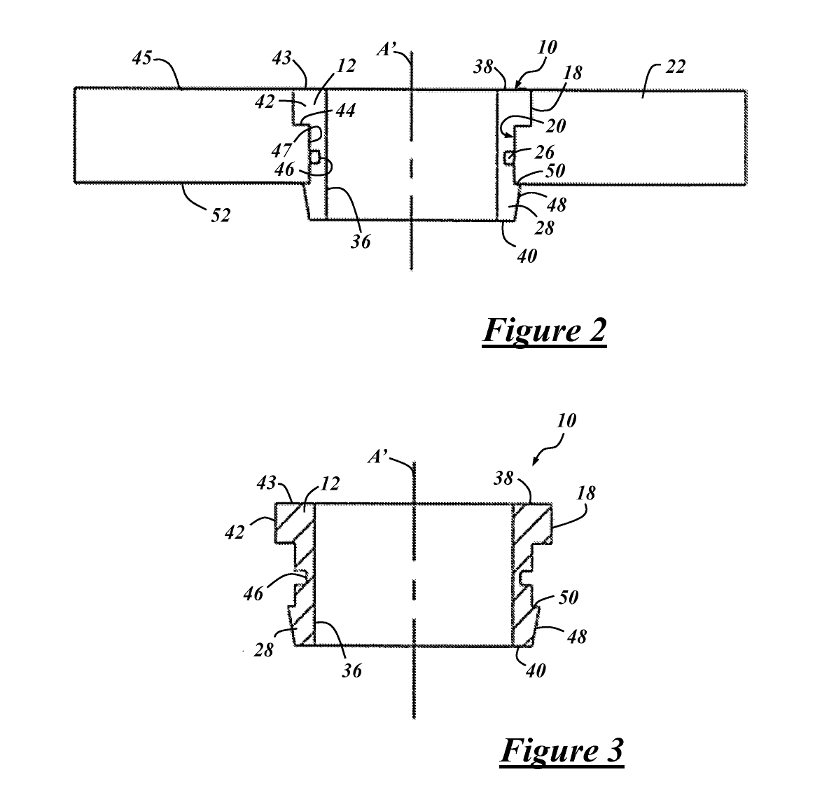

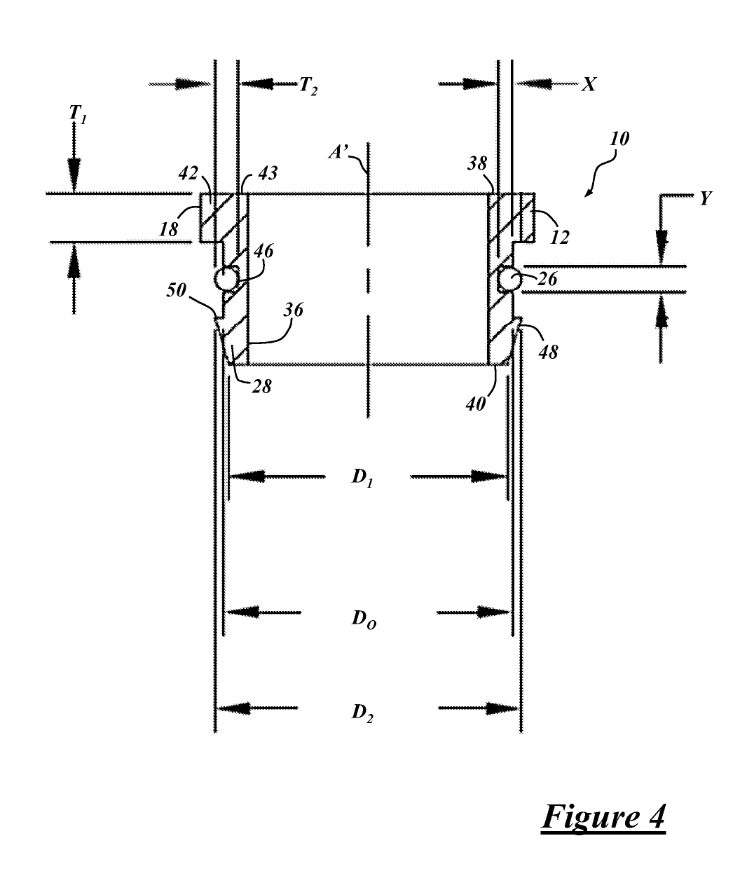

As shown more particularly in FIGS. 2-4, bearing 10 has a generally cylindrical outer surface 18 and a central cylindrical bore 36 extending between first and second axial ends 38, 40, defining a body 12. The outer surface 18 is preferably sized for press fitting into the opening 14 of the container 16 and/or the opening 20 in the agitator mounting structure 22. The central cylindrical bore 36 permits rotation of the agitator shaft 31 relative to the container housing 17 and is accordingly sized for close receipt of the agitator shaft 31. Although not shown, it should be noted that other restraining mechanisms may be used to retain the bearing 10 within the openings 14, 20, such as retaining rings or clips, for example. It should also be noted that “generally cylindrical” means that the surface need not be circular in cross-section or have a uniform diameter along its axial length or even that it be point-wise continuous around its circumference. For example, a radially-extending flange 42 at the first axial end 38 of the outer surface 18 rests in a shoulder 44 of the upper surface 45 of the agitator mounting structure 22 so as to prevent the bearing from passing through the opening 20. In the embodiment illustrated in FIG. 4, the flange 42 has an axial thickness T₁. T₁ is sized such that an upper surface 43 of the bearing 10 at the first axial end 38 is flush with a portion of the upper surface 45 of the agitator mounting structure 22 located adjacent the opening 20 of the agitator mounting structure 22, as shown in FIG. 2. In one embodiment, T₁ is approximately 0.25 inches. It should be noted that it is not necessary for the upper surface 45 of the agitator mounting structure 22 to include shoulder 44. For example, it is possible for the radially-extending flange 42 to rest on a generally planar upper surface of an agitator mounting structure.

The body 12 of the bearing 10 may be made from a polymeric material including, but not limited to, nylon, Delrin, phenolic, polytetrafluoroethylene (PTFE), or glass filled PTFE. Metallic materials may also be used, including but not limited to, bronze, iron and iron-based alloys, or aluminum. Depending on the deformability of the material used, the design of the locking tab 28 may need to be altered, as will be described in more detail below. As will be apparent to one having ordinary skill in the art, considerations to take into account when choosing a bearing material include the rate of wear of the bearing material, the coefficient of friction, the fatigue strength necessary to withstand the cyclic loading of the rotating agitator shaft, and corrosion resistance, among others. It is also possible for bearing 10 to serve as an inner ring for a multi-layer bearing including one or more outer rings (not shown).

With particular reference to FIG. 4, bearing 10 includes a first diameter D₁ and a second diameter D₂. The opening 20 in the agitator mounting structure 22 also includes a diameter D_{O}. As shown, locking tab 28 includes an inclined outer surface 48 that extends from the first diameter D₁ at the second axial end 40 towards the second axial end 38 to the second diameter D₂ adjacent the retention feature 50. In one particular embodiment, the first diameter D₁ is approximately 1.50 inches, the second diameter D₂ is approximately 1.525 inches, and the diameter of the opening D_{O} is approximately 1.505 inches. Thus, in this embodiment, the first diameter D₁ is smaller than the diameter of the opening D_{O} and the second diameter D₂ is larger than the diameter of the opening D_{O}.

Locking tab 28 is situated toward the second axial end 40 of the bearing 10. As previously described, any slight misalignment or deviation of the vertical axis A of the agitator shaft 31 with respect to the vertical axis A′ of the bearing assembly 10 may result in a tendency for axial movement of the bearing 10, and could otherwise eventually cause movement of the bearing out of its opening and undesirable metal-to-metal contact between the agitator shaft 31 and the top 24 of the container housing 17 and/or the opening 20 of the agitator mounting structure 22. Locking tab 28 may assist in establishing a positive lock of the bearing 10 and preventing such undesirable axial movement of the bearing. As shown in FIGS. 2-4, the inclined outer surface 48 of the locking tab 28 extends radially outward from the second axial end 40 of the bearing 10 to form the lower retention feature 50 of the locking tab 28. The lower retention feature 50 engages a lower surface 52 of the agitator mounting structure 22. In one embodiment, the lower retention feature 50 has a radial width of approximately 0.02 inches. Upon installation of the bearing 10 into the opening 20 of the agitator mounting structure 22, the bearing 10 may be positively locked in place within the opening 20 by engagement of the flange 42 with the upper surface 45 of the agitator mounting structure 22 and engagement of the retention feature 50 of the locking tab 28 with the lower surface 52 of the agitator mounting structure 22. By restraining axial movement, the locking tab 28 may provide some protection from an unwanted metal-to-metal interface despite deviations between the vertical axis A of the agitator shaft 31 and the vertical axis A′ of the bearing 10.

Because the bearing 10 may be press fit into the opening 20 of the agitator mounting structure 22, the locking tab 28 must be capable of some sort of radial restriction. In one embodiment, the locking tab 28 compresses 0.025 inches during installation and then reopens to create a primary seal and lock the bearing in place. This may be accomplished by using a deformable or semi-deformable material, such as nylon or Delrin. Alternatively, the locking tab 28 may be equipped with a spring so as to form a locking detent mechanism. This may be more desirable if using bearing materials that allow for minimal deformation, such as metallic materials. In the illustrated embodiment, there is a single locking tab 28 that comprises an annular locking tab which extends circumferentially around the body 12 of the bearing 10. It should also be recognized that it may not be necessary for the locking tab 28 to extend the entire circumference of the outer surface 18 of the bearing 12. For example, the bearing 10 may have a plurality of individual locking tabs that extend radially from the second axial end 40 of the body 12 of the bearing 10 and that each extend circumferentially for only a short distance.

With reference to FIGS. 2-4, an annular groove 46 is formed in the outer surface 18 of the body 12 at an axial location between the flange 42 and the locking tab 28. As shown in FIG. 4, the annular groove 46 has a radial height X and an axial length Y. In one embodiment, the radial height X is approximately 0.06 inches and the axial length Y is approximately 0.072 inches such that the axial length Y is greater than the radial height X. The annular groove 46 receives O-ring 26 which, as shown in FIG. 2, is compressed between the groove 46 and an inner surface 47 of the opening 20 in the agitator mounting structure 22 whereby the O-ring 26 provides a secondary seal between the bearing 10 and the agitator mounting structure 22. The O-ring 26 is preferably made with a polymeric material, such as rubber, for example, so that the O-ring 26 is capable of stretching to facilitate assembly within the groove 46 in the bearing outer surface 18. O-ring 26 may be sized such that, prior to assembly on the bearing 10 and when it is in an otherwise relaxed (undeformed) state, the O-ring 26 has an inner diameter that is less than the minimum diameter of the groove 46 so that it is slightly stretched when in place within the groove. Also, the thickness of the material of O-ring 26 may be selected such that, when the bearing 10 is press fit into the opening 20 in the agitator mounting structure 22, the O-ring is compressed approximately 0.022 inches. Thus, as shown in FIG. 4, the O-ring 26 in this embodiment has a radial thickness T₂ that may be compressed by at least 0.022 inches relative to the uncompressed radial thickness of the O-ring.

It is to be understood that the foregoing description is of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” and “such as,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A locking bearing for use in a bulk mixing container, comprising:
a body extending from a first axial end to a second axial end and having a central cylindrical bore that receives an agitator shaft when in use, said body having an outer surface shaped for receipt within an opening of an agitator mounting structure of a bulk mixing container such that said bearing may be mounted to the bulk mixing container and the agitator shaft may extend into the bulk mixing container through said bore to permit rotation of the agitator shaft relative to the bulk mixing container to thereby stir contents within the bulk mixing container;
said body including a radially-extending flange at said first axial end for engagement with an upper surface of the agitator mounting structure at the opening in the bulk mixing container to thereby prevent said bearing from passing through the opening, and said body including at least one locking tab locating at said second axial end that extends radially from said body, said locking tab providing a lower retention feature that engages a lower surface of the agitator mounting structure at the opening when said bearing is installed through the opening, whereby said bearing may be positively locked in place within the opening by engagement of said flange with the upper surface of the agitator mounting structure and engagement of said retention feature of said locking tab with the lower surface of the agitator mounting structure.

2. A locking bearing as defined in claim 1, further comprising an annular groove formed in said outer surface of said body at an axial location between said flange and locking tab, said groove having a radial height and an axial length that is greater than said radial height.

3. A locking bearing as defined in claim 1, wherein said body is made from nylon, Delrin, phenolic, polytetrafluoroethylene (PTFE), or glass filled polytetrafluoroethylene (PTFE).

4. A locking bearing as defined in claim 1, wherein said at least one locking tab comprises a single locking tab.

5. A locking bearing as defined in claim 4, wherein said single locking tab comprises an annular locking tab that extends circumferentially around said body.

6. A locking bearing as defined in claim 5, wherein said locking tab includes an inclined outer surface that extends from a first diameter at said second axial end towards said first axial end to a second diameter adjacent said retention feature, and wherein said first diameter is smaller than a diameter of the opening in the agitator mounting structure and said second diameter is larger than the diameter of the opening.

7. A bulk mixing container, comprising:
a container housing having a bottom, at least one side wall, and a top;
an agitator mounting structure located at the top of said container housing and having an upper surface located outside said container housing and a lower surface located inside said container housing;
an agitator assembly including a shaft extending through an opening in said agitator mounting structure; and
a bearing comprising a body extending from a first axial end to a second axial end and having a central cylindrical bore, said body being mounted within said opening of said agitator mounting structure with said shaft extending into said container housing through said bore to permit rotation of said shaft relative to said container housing to thereby stir contents within said container housing;
said body including a radially-extending flange at said first axial end for engagement with said upper surface of said agitator mounting structure at said opening to thereby prevent said bearing from passing through said opening, and said body including at least one locking tab locating at said second axial end that extends radially from said body, said locking tab providing a lower retention feature that engages said lower surface of said agitator mounting structure at said opening, whereby said bearing is positively locked in place within said opening by engagement of said flange with said upper surface of said agitator mounting structure and engagement of said retention feature of said locking tab with said lower surface of the agitator mounting structure.

8. A bulk mixing container as defined in claim 7, further comprising:
an annular groove formed in said outer surface of said body at an axial location between said flange and locking tab; and
an O-ring located in said groove;
wherein said O-ring is compressed between said groove and an inner surface of said opening in said agitator mounting structure, whereby said O-ring provides a secondary seal between said bearing and said agitator mounting structure.

9. A bulk mixing container as defined in claim 8, wherein said O-ring has a radial thickness that is compressed by at least 0.022 inches relative to the uncompressed radial thickness of the O-ring.

10. A bulk mixing container as defined in claim 7, wherein said body is made from nylon, Delrin, phenolic, polytetrafluoroethylene (PTFE), or glass filled polytetrafluoroethylene (PTFE).

11. A bulk mixing container as defined in claim 7, wherein said at least one locking tab comprises a single locking tab.

12. A bulk mixing container as defined in claim 11, wherein said single locking tab comprises an annular locking tab that extends circumferentially around said body.

13. A bulk mixing container as defined in claim 7, wherein said locking tab includes an inclined outer surface that extends from a first diameter at said second axial end towards said first axial end to a second diameter adjacent said retention feature, and wherein said first diameter is smaller than a diameter of the opening in the agitator mounting structure and said second diameter is larger than the diameter of the opening.

14. A bulk mixing container as defined in claim 7, wherein said opening includes a recessed shoulder that defines a recessed portion of the upper surface of said agitator mounting structure, wherein said flange engages said recessed shoulder and has an axial thickness such that an upper surface of said bearing at said first end is flush with a portion of said upper surface of said agitator mounting structure located adjacent said opening.
